(19) United States
(12) Patent Application Publication
(10) Pub. No.: US 2005/0049907 A1
(43) Pub. Date: Mar. 3, 2005

(54) Using page-view data to project demand for an item

(76) Inventors: Suresh Kumar, Issaquah, WA (US); Krishna Motukuri, Seattle, WA (US); Lekha Achuthan Bhargavi, Seattle, WA (US); Bryan Lee Taylor, Seattle, WA (US); Sachin Jain, Issaquah, WA (US); Amar Zumkhawala, Seattle, WA (US)

Correspondence Address: PERKINS COIE LLP;PATENT-SEA, P.O. BOX 1247, SEATTLE, WA, 98111-1247, US

(21) Appl. No.: 10/647,975

(22) Filed: Aug. 26, 2003

(51) Int. Cl. G06F 17/60

(52) U.S. Cl. 705/10

(57) ABSTRACT

A facility for projecting future purchasing activity for a selected item being offered for sale by a merchant is described. The facility retrieves data indicating, during each plurality of past times, an observed level of browsing activity performed at the merchant with respect to the selected item. The facility transforms the retrieved data into a projection of future purchasing activity at the merchant for the selected item.

### TECHNICAL FIELD

The present invention is directed to the fields of electronic commerce and statistical analysis.

### BACKGROUND

Every merchant is in the business of making items available for purchase by purchasers. Many merchants do or would find it helpful to have an accurate forecast of future purchasing activity for some or all of these items. Such a forecast indicates what quantities of an item will be sold at each of a number of future times, at each of one or more merchant locations, such as stores or distribution centers.

Such a forecast, if accurate, can help ensure that adequate resources are available to facilitate the forecasted purchases, such as inventory in the item, storage capacity for the inventory, inventory in complementary items (e.g., batteries of the type used in the item), or workers needed to support purchasing activities. Such a forecast may also enable the merchant to make a more accurate projection of future financial performance, allowing the merchant to better plan for various cash flow issues. Such a forecast may also enable merchants to better target promotional initiatives, such as advertising, item placement, sales, etc.

Unfortunately, it is not often possible to produce accurate projections, as conventional approaches to constructing them have significant disadvantages. In a first conventional approach, future purchasing activity is projected based upon past purchasing activity of the same item. Such projections are unfortunately merely rough guesses, as there is sometimes no meaningful relationship between past purchasing activity and future purchasing activity. Accordingly, this approach can require substantial manual “sales case” analysis to achieve anything approaching a significant likelihood of accuracy. Also, it is impossible to make projections using the first approach where past purchasing activity does not exist—as is true for new items that have not yet been available to purchase—or where past purchasing activity is limited by some factor external to demand, such as lack of inventory during a stock-out period, or inability of customers to purchase when a credit card authorization system is out of service.

In a second conventional approach, future purchasing activity is projected based upon past purchasing activity of an analogous item. When pursuing this approach it can be difficult or impossible to identify analogs whose purchasing activity the item in question will mirror. Further, even in cases in which it is possible to identify a useful analog, it is often difficult to match the analog's purchasing activity against that of the item in question.

In view of the substantial shortcomings of conventional approaches to projecting future purchasing activity for an item, a more effective approach to doing so would have significant utility.

### BRIEF DESCRIPTION OF THE DRAWINGS

FIG. 1 is a high-level block diagram showing a typical environment in which the facility operates.

FIG. 2 is a data flow diagram depicting a first approach used by the facility to generate a blended purchasing forecast for an item.

FIG. 3 is a graph showing the facility's generation of a sample blended purchasing forecast in accordance with the first approach.

FIG. 4 is a data flow diagram depicting a second approach used by the facility to generate a blended purchasing forecast for an item.

FIG. 5 is a graph showing the facility's generation of a sample blended purchasing forecast in accordance with the second approach.

FIG. 6 is a data flow diagram showing a third approach used by the facility to generate a purchasing forecast for an item.

### DETAILED DESCRIPTION

A software facility for projecting future purchasing activity of an item based on past browsing activity for the item (“the facility”) is described.

In some embodiments, for a web-based merchant offering items for sale, for each item, the facility identifies types of HTTP requests that, when received from client computer systems being used by customers, constitute a browsing activity for the item. The identified requests can include such requests as the following: a request for a page containing information about multiple items that include that item (such as an item category page), a request for a page containing information only about that item (such as an item detail page), a request for a page containing further information about that item (such as a page containing item reviews), a request for signing up to be notified when the item becomes available, a request adding the item to a shopping cart or a gift registry, a search request specifying a query string for matching items of interest, etc. The facility typically extracts and counts requests of these types from web server logs produced by the merchant's web site to generate past browsing activity metrics for each item.

In some embodiments, the facility uses the past browsing activity metrics to project future browsing activity, then converts the projection of future browsing activity into a projection of future purchasing activity. Alternatively, in some embodiments, the facility uses the past browsing activity metrics to directly project future purchasing activity. In some embodiments, the facility blends the projection of future purchasing activity produced directly or indirectly from the past browsing activity metrics with a parallel projection of future activity generated from past purchasing activity. In some embodiments, the facility projects future purchasing activity directly from past browsing activity and past purchasing activity.

In many cases, the facility produces forecasts of future purchasing activity that are significantly more accurate than conventional approaches. The facility can generally produce a future purchasing activity forecast for any item for which browsing activity information is available, irrespective of the availability or cohesiveness of past purchasing activity information, and irrespective of whether analogous items exist or have been identified.

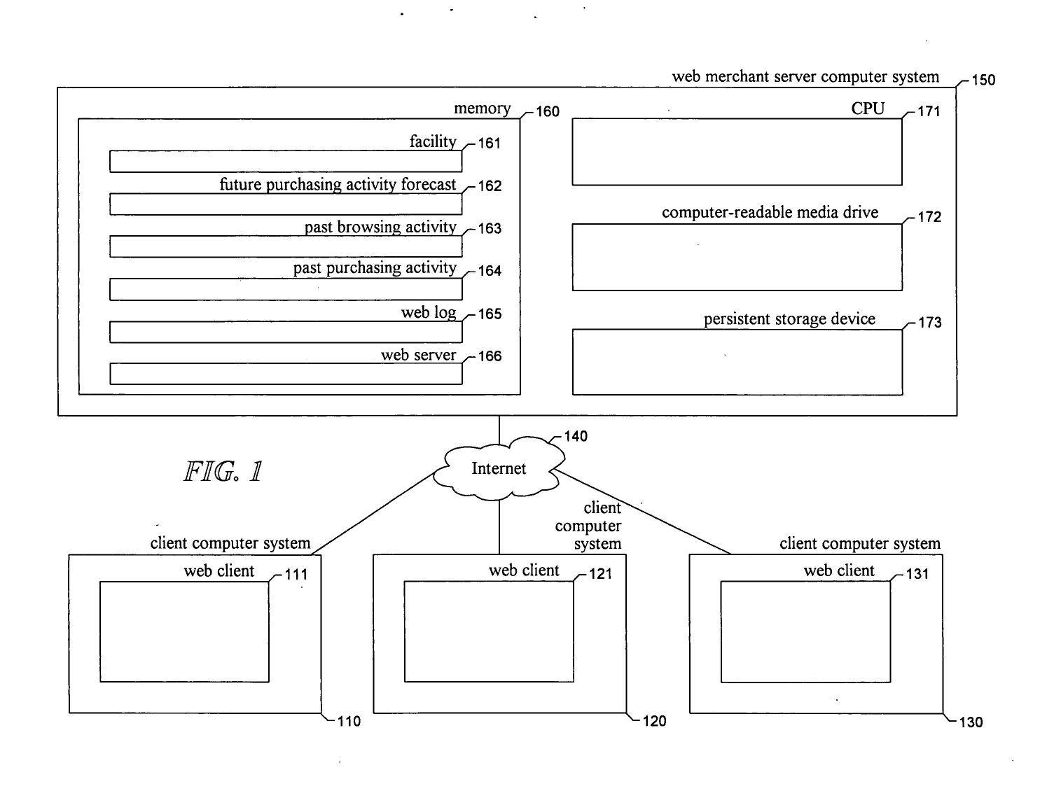

FIG. 1 is a high-level block diagram showing a typical environment in which the facility operates. The block diagram shows several client computer systems, such as client computer systems 110, 120, and 130. Each of the client computer systems has a web client computer program for browsing the World Wide Web, such as web clients 111, 121, and 131. The client computer systems are connected via the Internet 140 to a web merchant server computer system 150 hosting the facility. Those skilled in the art will recognize that client computer systems could be connected to the server computer system by networks other than the Internet, however. By using the World Wide Web to communicate with the web merchant server computer system, users of the client computer systems can perform browsing and purchasing activities with respect to items offered for sale by the web merchant.

The web merchant server computer system 150 contains a memory 160. The memory 160 preferably contains the facility 161 for projecting future purchasing activity of an item. The facility typically constructs a future purchasing activity forecast 162 using information about past browsing activity 163, or information about past browsing activity in conjunction with information about past purchasing activity 164. Information about these activities is typically extracted from a web log 165 produced by a web server computer program 166 for delivering web pages in response to requests from web clients. Those skilled in the art will appreciate that information about past browsing activity and/or past purchasing activity may be derived from a variety of different sources, in a variety of different manners. While items 161-166 are preferably stored in memory while being used, those skilled in the art will appreciate that these items, or portions of them, maybe be transferred between memory and a persistent storage device 172 for purposes of memory management and maintaining data integrity. The server computer system further contains one or more central processing units (CPU) 171 for executing programs, such as programs 161 and 166, and a computer-readable medium drive 173 for reading or writing information or installing programs such as the facility from computer-readable media, such as a floppy disk, a CD-ROM, or a DVD.

While various embodiments are described in terms in the environment described above, those skilled in the art will appreciate that the facility may be implemented in a variety of other environments including a single, monolithic computer system, a distributed system, as well as various other combinations of computer systems or similar devices connected in various ways.

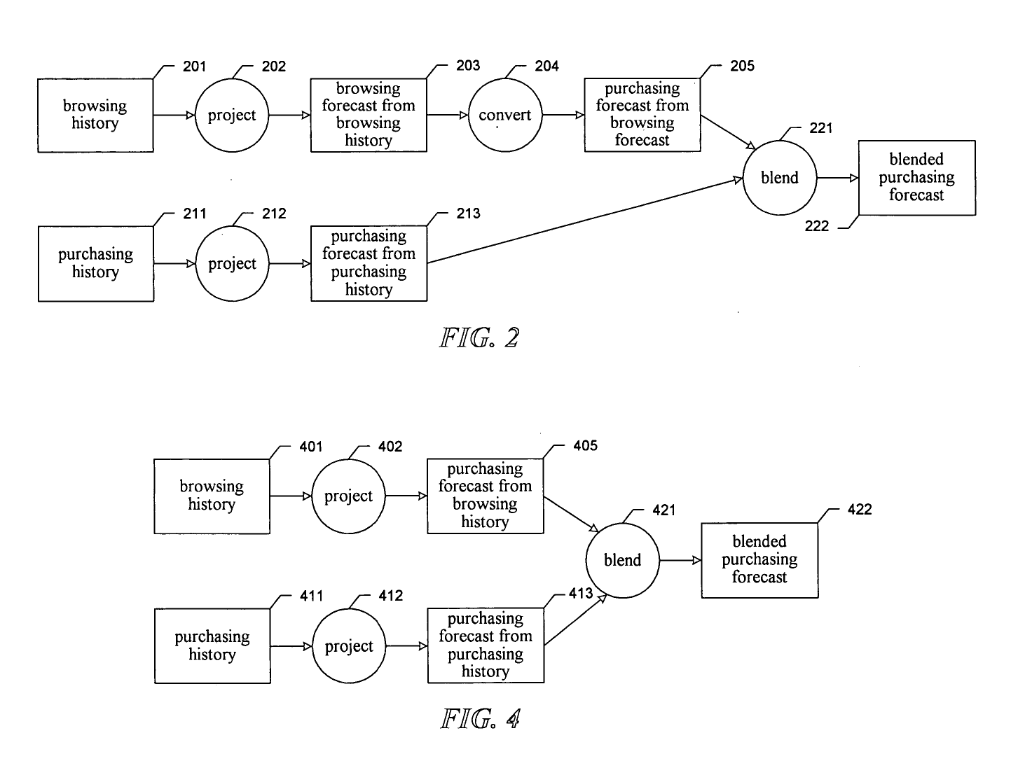

FIG. 2 is a data flow diagram depicting a first approach used by the facility to generate a blended purchasing forecast for an item. The facility begins with two types of information about past activity with respect to the item: browsing history information 201 and purchasing history information 211 documenting browsing and purchasing activities performed at a web merchant.

The browsing history information 201 describes browsing activities that have recently been performed by customers with respect to the item. Examples of these activities are discussed above. In some embodiments, the browsing history information constitutes an array indexed in one dimension by time. As discussed further below, in some embodiments, the array is indexed in another dimension by activity type. Each value of the time index corresponds to one of a number of time buckets: recent, adjacent periods of time of an equal length, such as previous hours, previous days, or previous weeks. The browsing history information may have a single browsing activity value for each time bucket, or it may have several depending upon other index dimensions of the array. The array may have an activity-type dimension, enabling the array to contain separate browsing activity scores for each of a number of different browsing activity types. Alternatively, all of the different browsing activities may be combined into a single weighted browsing activity score. The array may also have an additional dimension indexed by item identifier, enabling the array to contain browsing activity scores for each of a number of different items offered for sale by the merchant.

In some cases, browsing activity scores each constitute a count of the number of times one or more browsing activities were performed within the time bucket for a particular item. In some cases, however, the score is a count of the number of unique users that performed the browsing action or actions. In some cases, the individual browsing action occurrences making up the score are weighted based upon the past history of the browsing action occurrences in successfully predicting orders for the item. Such weighting may be based on a variety of factors, including the type of browsing action, the identity of the user performing the browsing action, the identity of a referrer web site that sent the user to the merchant's web site, etc.

In transformation 202, the facility projects a browsing forecast 203 from the browsing history 201. This projection, as well as other projections discussed below, can be performed using a wide variety of statistical techniques, including projection techniques discussed in U.S. patent application Ser. No. 10/406,626, filed Apr. 3, 2003, which is hereby incorporated by reference in its entirety. Projection techniques used by some embodiments of the facility include moving average, exponential smoothing, Box-Jenkins ARIMA models, two or more of which may be combined in hybrid approaches. The browsing forecast 203 is typically an array containing, for each of a number of future time buckets, a browsing activity score predicted for that future time bucket.

In transformation 204, the facility transforms the browsing forecast 203 into a purchasing forecast 205. The purchasing forecast is a projection of purchasing activity that will occur with respect to the item during each of a number of future time buckets. Such purchasing activity may take many forms, including adding the item to a shopping cart, checking out with the item in the shopping cart, initiating a one-click purchase for the item, providing payment information in connection with ordering the item, shipping the item, taking physical delivery of the item by the purchaser, etc. A purchasing activity score may simply be a count of the expected number of occurrence of such purchasing actions, or may be a more complex weighted score based upon the numbers of such actions. In some embodiments, the conversion transformation is sensitive to such variables as time, item price, item availability, item sales cycle, and other sources of demand elasticity that affect the rate of conversion from browsing activity to purchasing activity. The facility projects a time-series of conversion ratios based on conversion history and some or all of the variables mentioned above. The facility applies this conversion ratio to the browsing forecast to produce a purchasing forecast.

This conversion projection may be generated as a function of the variables mentioned above, and not necessarily simply as numbers. As one example, output could be of the form <N, 0.3>, <Y, 0.5>for each week in the forecast horizon where N indicates the item will not be available and Y indicates that it will be available. The above example considers only one variable, availability, but it can be extended to other variables and the representation of the conversion data could change accordingly. For instance, where price is a variable, embodiments of the facility use different values of conversion at different price tiers. Alternatively, the facility uses a function like:
c=0.8−(p−10)*0.1
Where the facility uses this function, for every dollar increase in price, p, above $10, the conversion, c, drops by 0.1 points. In some embodiments, such functions are bounded to keep the conversion factors between 0 and 1.

In transformation 212, the facility uses purchasing history information 211 for the item to project a purchasing forecast 213. In transformation 221, the facility blends the purchasing forecast 205 from the browsing forecast and the purchasing forecast 213 from the purchasing history to obtain a blended purchasing forecast 222. The blending transformation determines, for each future time bucket, how heavily to weight the browsing activity score for that time bucket from each of the two purchasing forecasts in generating the blended purchasing forecast. In some embodiments, in the blending transformation, the facility weights the purchasing forecast from browsing forecast more heavily where the item went out of stock at the merchant at least once during the past time buckets that make up the purchasing history, as the resulting unavailability of the item may have prevented customers that intended to purchase the item during those time buckets from doing so, thus influencing the purchasing activities measured in the purchasing history.

In some embodiments, the facility performs blending using a function such as:
bl=a·h+b·f
where bl is the blended forecast, h is the purchasing forecast from the browsing forecast 205 and f is the purchasing forecast 213 from purchasing history for each time bucket. a and b are coefficients that typically satisfy the properties (1) 0<=a,b and (2) a+b=1, though in some situations, the second property is not maintained. Since h and f are inputs, the facility computes coefficients a and b. As in the case of the conversion model, these coefficients may also be generated as functions of the variables such as time, availability, price, etc. For instance, in some embodiments, the facility uses a=0 and b=1 if the item is expected to be out-of-stock in the future, and uses a=1 and b=0 if the item is expected to be available in the period under consideration. In some embodiments, the facility performs blending uniformly across all items, while in other embodiments the facility individually tailors the blending process somewhat to each item.

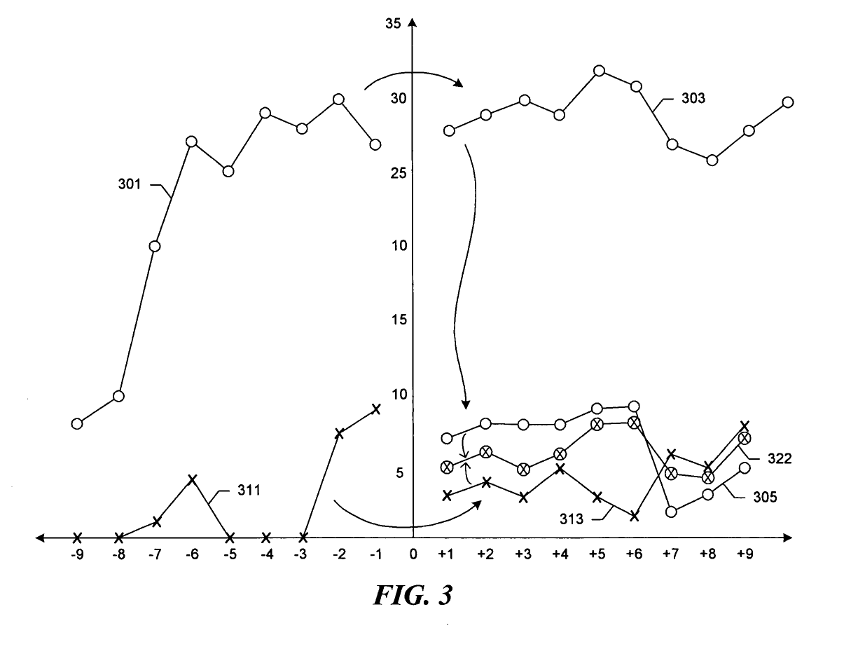

FIG. 3 is a graph showing the facility's generation of a sample blended purchasing forecast in accordance with the first approach. The X-axis of the graph shows time buckets, including feature time buckets having positive values and past time buckets having negative values. The origin on the X-axis shows what is roughly the present time. The Y-axis shows a quantitative indication of browsing and purchasing activity for the item, such as a raw number of browsing or purchasing actions, or a weighted score produced from the number of such actions performed.

Time series 301 corresponds to browsing history 201, and is comprised of the following nine data points: (−9, 8), (−8, 10), (−7, 20), (−6, 27), (−5, 25), (−4, 29), (−3, 28), (−2, 30), and (−1, 27). For example, the first of these points indicates that, in the −9 time bucket (such as the 1-day time bucket occurring nine days before the present time), the browsing activity score for the item was 8, which might either correspond to a count of item browsing events, such as visits to the item's detail page, or may correspond to a weighted score generated from a wider variety of browsing actions. In accordance with projection transformation 202, time series 301 is transformed into time series 303, corresponding to browsing forecast 203. Time series 303 is in turn converted by conversion transformation 204 into time series 305, corresponding to purchasing forecast from browsing forecast 205.

Time series 311 corresponds to purchasing history information 211. It can be seen that the purchasing activity scores in this time series are zero, both during past time buckets −9 through −8 and past time buckets −5 through −3. It may be that the item first became available for sale during bucket −7, making it impossible or unproductive to perform purchasing activities for the item in buckets −9 and −8. Additionally, the merchant's initial stock in the item may have been exhausted for time buckets −5 through −3, during which a purchasing activity score of zero was again registered. In the projection transformation 212, the facility transforms time series 311 into time series 313, corresponding to the purchasing forecast 213 from purchasing history. The facility then uses the blending transformation 221 to transform time series 305 and time series 313 into time series 322, corresponding to the blended purchasing forecast 222.

The blended purchasing forecast represented by time series 322 may be used to anticipate future purchasing activity with respect to the item, and to set operating parameters with respect to the item such as inventory in the item, inventory in the item's complements, staffing levels among employees needed to sell the item, etc. Alternatively, the purchasing forecast represented by time series 305, corresponding to purchasing forecast from processing forecast 205, may be used to anticipate future purchasing activity with respect to the item.

FIG. 4 is a data flow diagram showing a second approach used by the facility to generate a blended purchasing forecast for an item. In the second approach, in projection transformation 402, the facility directly projects a purchasing forecast 405 from browsing history information 401. In a manner similar to the first approach, in the second approach, the facility projects a purchasing forecast 413 from purchasing history information 411. The purchasing forecast from browsing activity 405 and purchasing forecast from purchasing history 413 are combined in a blending transformation 421 to produce a blended purchasing forecast 422.

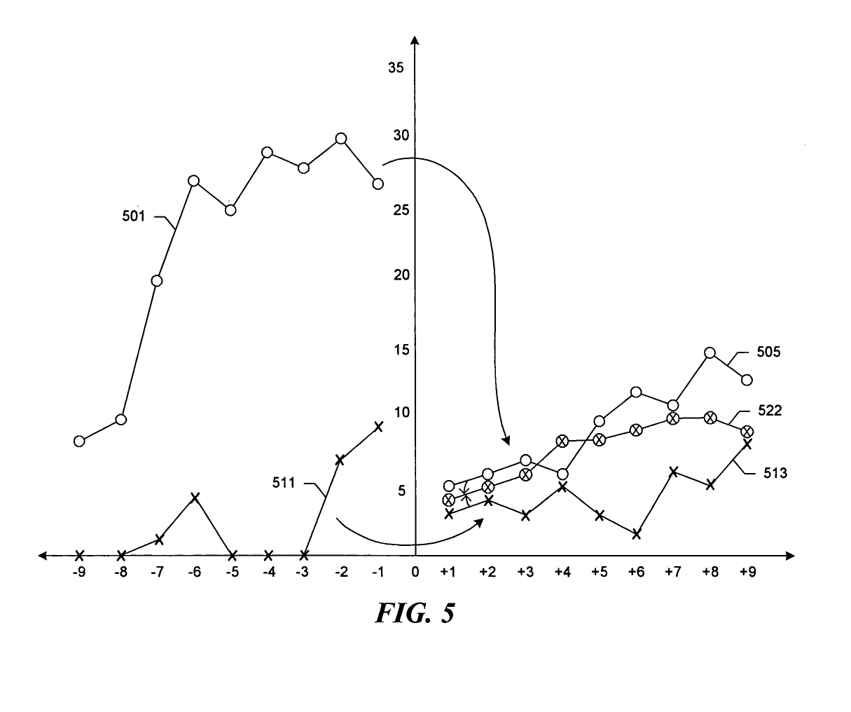

FIG. 5 is a graph showing the facility's generation of a sample blended purchasing forecast in accordance with the second approach. In FIG. 5, time series 501 corresponding to browsing history information 401 is transformed by projection transformation 402 into time series 505 corresponding to purchasing forecast information 405 from browsing history. Time series 511 corresponding to purchasing history 411 is transformed by projection transformation 412 into time series 513 corresponding to purchasing forecast information 413 from purchasing history. Time series 405 and time series 413 are combined by blending transformation 421 into time series 522, corresponding to blended purchasing forecast 422. The time series produced may be used in a manner similar to that described above in conjunction with the time series shown in FIG. 3.

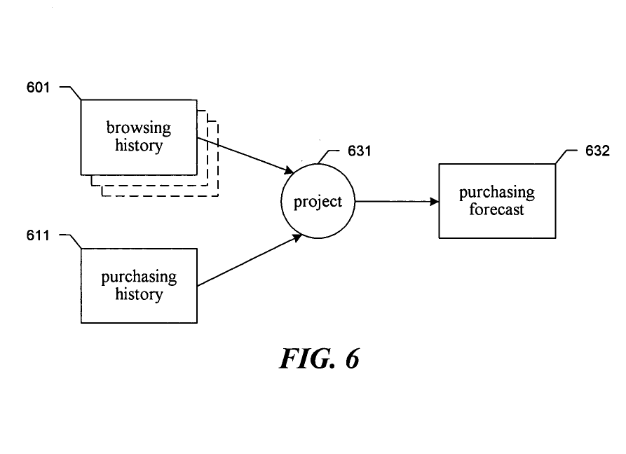

FIG. 6 is a data flow diagram showing a third approach used by the facility to generate a purchasing forecast for an item. In the third approach, in projection transformation 631, the facility directly projects a unified purchasing forecast 632 from browsing history information 601 and purchasing history information 611. In some embodiments, purchasing history information 611 comprises a single time series containing the item's purchasing history, and the browsing history information 601 contains either (1) a single time series corresponding to all of the browsing history information associated with the item, or (2) a number of different time series, each corresponding to the performance of a different browsing action performed with respect to the item. In some embodiments, projection transformation 631 uses a best-pick statistical technique, such as the versions of this technique described in Box et al., “Time Series Analysis: Forecasting & Control,” Prentice Hall, 3^{rd} Edition, Feb. 28, 1994; Brockwell et al., “Introduction to Time Series and Forecasting,” Springer Verlag, 2^{nd} Book Edition, Mar. 8, 2002; Hamilton, James D., “Time Series Analysis,” Princeton University Press, Jan. 11, 1994; Fuller, Wayne A., “Introduction to Statistical Time Series;” John Wiley & Sons, 2^{nd} Edition, December 1995; and, Arsham, Hossein, “Time Series Analysis and Forecasting Techniques,” Feb. 18, 1994, http://www.ubmail.ubalt.edu/˜harsham/stat-data/opre330Forecast.htm, each of which is hereby incorporated by reference in its entirety.

It will be appreciated by those skilled in the art that the above-described facility may be straightforwardly adapted or extended in various ways. For example, the facility may be used by a wide variety of merchants, and may project future purchasing activity of a variety of types based upon past browsing activity and/or purchasing activity that take a variety of forms and are observed in a variety of ways. While the foregoing description makes reference to preferred embodiments, the scope of the invention is defined solely by the claims that follow and the elements recited therein.

1. A method in a computing system for projecting future purchasing activity for a selected item, comprising:
compiling historical browsing data indicating, for each of a plurality of foregoing time periods, a level of item browsing activity performed with respect to the selected item;
generating from the compiled historical browsing data a first projection of future purchasing activity levels with respect to the selected item;
compiling historical purchasing data indicating, for each of a plurality of foregoing time periods, a level of item purchasing activity performed with respect to the selected item;
generating from the compiled historical purchasing data a second projection of future purchasing activity levels with respect to the selected item; and
blending the generated first and second projections of future purchasing activity levels with respect to the selected item to generate a third projection of future purchasing activity levels with respect to the selected item.

2. The method of claim 1, further comprising placing a resupplying order for the selected item based upon the third projection.

3. The method of claim 1 wherein the first, second, and third projections of future purchasing activity levels each specify a level of purchasing activity with respect to the selected item during each of a plurality of target time periods following the foregoing time periods,
and wherein the blending comprises, for each of the plurality of target time periods:
weighting the level specified by the first projection relative to the level specified by the second projection, and
combining the levels specified by the first and second projections in accordance with their weights,
the method further comprising determining that an external event occurred that is likely to have influenced the level of item purchasing activity performed with respect to the selected item during a selected one of the plurality of target time periods,
and wherein the weighting for the selected target time period downgrades the weight of the level specified by the second projection relative to the level specified by the first projection.

4. The method of claim 3 wherein the external event determined to have occurred is an external event that is likely to have limited the availability of the selected item.

5. The method of claim 3 wherein the external event determined to have occurred is an external event that is likely to have prevented the purchase of the selected item.

6. A computer-readable medium whose contents cause a computing system to project future purchasing activity for a selected item by:
compiling historical browsing data indicating, for each of a plurality of foregoing time periods, a level of item browsing activity performed with respect to the selected item;
generating from the compiled historical browsing data a first projection of future purchasing activity levels with respect to the selected item;
compiling historical purchasing data indicating, for each of a plurality of foregoing time periods, a level of item purchasing activity performed with respect to the selected item;
generating from the compiled historical purchasing data a second projection of future purchasing activity levels with respect to the selected item; and
blending the generated first and second projections of future purchasing activity levels with respect to the selected item to generate a third projection of future purchasing activity levels with respect to the selected item.

7. A method in a computing system for projecting future purchasing activity for a selected item being offered for sale by a merchant, comprising:
retrieving data indicating, during each of a plurality of past time periods, an observed level of browsing activity performed by users with respect to the selected item; and
transforming the retrieved data into a projection of future purchasing activity at the merchant for the selected item.

8. The method of claim 7 wherein the transforming produces a projection of future purchasing activity specifying an anticipated level of purchasing activity for each of a plurality of future time periods.

9. The method of claim 7 wherein the transforming comprises:
using the retrieved data to generate a projection of future browsing activity performed at the merchant with respect to the selected item, and
using the generated projection of future browsing activity to predict future purchasing activity at the merchant for the selected item.

10. The method of claim 9 wherein the projection is generated using time-series forecasting techniques.

11. The method of claim 9 wherein the projection of future browsing activity generated is a time-series of values characterizing future browsing activity at each of a plurality of future times, and wherein future purchasing activity is predicted by applying a time-series of conversion ratios based upon conversion history at the merchant.

12. The method of claim 7 wherein the merchant operates a web site, and wherein a web log is produced in connection with the operation of the web site, further comprising:
extracting browsing activity data from the produced web log; and
storing the extracted data for retrieval.

13. The method of claim 7 wherein the merchant operates a physical store, further comprising:
capturing browsing activity data within the physical store; and
storing the captured data for retrieval.

14. The method of claim 7 wherein the merchant operates a plurality of locations at which the selected item is available for purchase, and wherein the transforming is performed to produce a projection of future purchasing activity specifying an anticipated level of purchasing activity for each of the plurality of merchant locations.

15. The method of claim 14 wherein each of the locations operated by the merchant is a shipping center,
and wherein, for each shipping center, the anticipated level of purchasing activity is determined using browsing activity data from customers whose shipping address is associated with the shipping center.

16. The method of claim 14 wherein each of the locations operated by the merchant is a shipping center,
and wherein, for each shipping center, the anticipated level of purchasing activity is determined using browsing activity data from customers whose shipping address is associated with any of the shipping centers.

17. The method of claim 7, further comprising using the projection of future purchasing activity to specify an operational parameter used to operate the merchant.

18. The method of claim 17 wherein the specifying operation parameter is inventory reorder level for the selected item.

19. The method of claim 17 wherein the specifying operation parameter is inventory reorder level for an item identified as a complement of the selected item.

20. The method of claim 17 wherein the specifying operation parameter is staffing level.

21. The method of claim 7 wherein the retrieved data indicates an observed level of browsing activity performed by the user at the merchant.

22. The method of claim 7, further comprising incorporating into the projection of future purchasing activity data indicating, during each of a plurality of past time periods, an observed level of purchasing activity performed by users with respect to the selected item.

23. A computing system for projecting future purchasing activity for a selected item being offered for sale on a merchant's web site, comprising:
a retrieval subsystem that retrieves data indicating, during each of a plurality of past time periods, an observed level of browsing activity performed by users with respect to the selected item; and
a transformation subsystem that transforms the retrieved data into a projection of future purchasing activity at the merchant for the selected item.

24. The computing system of claim 23 wherein the retrieval subsystem retrieves data indicating an observed level of browsing activity performed by users at the merchant's web site.

25. The computing system of claim 23 wherein the retrieval subsystem retrieves data indicating an observed level of browsing activity performed by users at a plurality of web sites, including the merchant's web site.

26. One or more computer memories collectively containing an item purchasing activity forecasting data structure comprising, for a selected item, for each of a series of past times, an indication of a level of item browsing activity observed to take place with respect to the selected item, such that the contents of the data structure may be used to project future purchasing activity with respect to the selected item.

27. The computer memories of claim 26 wherein each indication is a count of the total number of times an item detail web page containing information about the selected item was requested from one or more web servers from which the item detail page is available.

28. The computer memories of claim 26 wherein each indication is a count of the total number of item browsing events observed to take place with respect to the selected item.

29. The computer memories of claim 26 wherein each of a plurality of different item browsing actions may be performed with respect to the selected item, and wherein each indication is a weighted score based upon the number of times each of the item browsing actions were observed to take place with respect to the selected item.

30. The computer memories of claim 27 wherein the data structure contains indications of levels of item browsing activity observed to take place at each of the series of past times with respect to each of a plurality of items, such that the contents of the data structure may be used to project future purchasing activity with respect to any of the plurality of items.

31. The computer memories of claim 30 wherein in the data structure is organized in such a manner that the plurality of items are ranked in descending order of their indications of levels of item browsing activity, such that the contents of the data structure may be used to determine a relative level of urgency for restocking the items of the plurality.

32. The computer memories of claim 27 wherein the each indication for a past time contained by the data structure comprises, for each of a plurality of different item browsing action types, a count of the total number of actions of the item browsing action type observed to take place at the past time.

33. One or more computer memories collectively containing an item purchasing activity forecast data structure comprising, for a selected item, for each of a series of future times, an indication of a level of purchasing activity expected to take place with respect to the selected item, based at least in part upon a quantification of browsing activity previously observed with respect to the selected item.

34. The computer memories of claim 33 wherein the data structure contains indications of levels of purchasing activity expected to take place at each of the series of future times with respect to each of a plurality of items, based at least in part upon a quantification of browsing activity previously observed with respect to the plurality of items.

35. The computer memories of claim 33 wherein the indications contained by the data structure are also based upon a quantification of purchasing activity previously observed with respect to the selected item.

36. One or more computer memories collectively containing a browsing action weighting data structure comprising, for each of a plurality of different types of item browsing actions, a indication of a weight to be attributed to item browsing actions of the type in projecting future demand based upon the occurrences of item browsing actions of the type.
